(19) United States
(12) Patent Application Publication
(10) Pub. No.: US 2026/0155446 A1
(43) Pub. Date: Jun. 4, 2026

(54) Electrolyte Formulations for Ultra-Fast Chargeable Battery Electric Vehicle Cell

(71) Applicant: GM Global Technology Operations LLC, Detroit, MI (US)

(72) Inventors: Dewen Kong, Shanghai (CN); Haijing Liu, Shanghai (CN); Si Chen, Shanghai (CN); Meinan He, Birmingham, MI (US)

(21) Appl. No.: 19/073,623

(22) Filed: Mar. 7, 2025

(30) Foreign Application Priority Data
Dec. 3, 2024 (CN) 202411764063.4

(51) Int. Cl. H01M 10/0569; H01M 4/02; H01M 4/36; H01M 4/38; H01M 4/583; H01M 10/0567; H01M 10/0568

(52) U.S. Cl. CPC H01M 10/0569; H01M 4/364; H01M 4/386; H01M 4/583; H01M 10/0567; H01M 10/0568; H01M 2004/027; H01M 2220/20; H01M 2300/0037; H01M 2300/0051

(57) ABSTRACT

An electrolyte for a battery cell, a battery cell for a vehicle, and a method of forming an electrolyte. The electrolyte includes a carbonate solvent, a primary lithium salt present in the solvent at a concentration in the range of 0.6 M to 2.0 M, a secondary lithium salt optionally present in the solvent at a concentration in the range of 0.1 M to 0.5 M. The electrolyte further includes a phenyl additive including at least one of a fluorine substituent and a fluorinated substituent, the phenyl additive present in an amount of 0.5 percent by weight to 20 percent by weight of the total weight of the electrolyte, and a co-additive present in the range 0.1 weight percent to 20 weight percent of the total weight of the electrolyte.

### BACKGROUND

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides the source of lithium ions and determines the capacity and average voltage of a battery. The anode stores and releases lithium ions received from the cathode when energy is needed, the separator prevents the cathode and anode from contacting and shorting out the battery, and the electrolyte provides a medium between the cathode and anode through which the lithium ions travel.

Battery performance may be quantified by a number of properties including energy density, power density, specific energy, specific power, charge rate, discharge rate, capacity decay, cycle life, thermal performance, and aging. Of particular interest is increasing vehicle charge rate to reduce vehicle charge time. Vehicle charging rates may range from 20 minutes to two or more days, depending on the charger type and vehicle battery. To improve charging rate and other metrics, the materials used to form the cathode, anode, separator, and electrolytes and how those materials are formed have been the subject of numerous development efforts. Included in the development efforts is exploration of various electrolyte additives.

Thus, while present electrolyte chemistries and other battery materials achieve their intended purpose, there is a need for new and improved electrolyte chemistries that offer relatively improved charging rate and other performance metrics.

### SUMMARY

According to various aspects, the present disclosure relates to an electrolyte for a battery cell. The electrolyte includes a carbonate solvent, a primary lithium salt including lithium hexafluorophosphate present in the solvent at a concentration in the range of 0.6 M to 2.0 M, a secondary lithium salt optionally present in the solvent at a concentration in the range of 0.1 M to 0.5 M. The total concentration of the primary lithium salt and the secondary lithium salt if present is up to 2.0 M. The electrolyte further includes a phenyl additive including at least one of a fluorine substituent and a fluorinated substituent, the phenyl additive present in an amount of 0.5 percent by weight to 20 percent by weight of the total weight of the electrolyte, and a co-additive present in the range 0.1 weight percent to 20 weight percent of the total weight of the electrolyte, wherein the remainder weight percent includes the carbonate solvent, the primary lithium salt, and the secondary lithium salt, and the total weight of the electrolyte is 100 weight percent.

In embodiments of the above, the secondary lithium salt is lithium bis(fluorosulfonyl)imide.

In any of the above embodiments, the carbonate solvent includes a mixture of ethylene carbonate present in the range of 20 percent to 40 percent by volume of the solvent, and a linear carbonate present in the range of 60 percent to 80 percent by volume of the solvent, wherein the total percent by volume of the solvent is 100 percent. In further embodiments, ethyl acetate is present in the range of 1 percent to 20 percent by volume of the solvent, wherein the total percent by volume of the solvent is 100 percent. In additional, further embodiments, the linear carbonate includes at least one of ethylene carbonate, ethyl methyl carbonate, and diethyl carbonate.

In any of the above embodiments, the phenyl additive is fluorobenzene. Alternatively, or additionally, in any of the above embodiments, the phenyl additive exhibits the following formula:

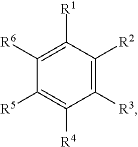

wherein at least one of R1, R2, R3, R4 R5, and R6 is a fluorine, a fluorinated alkyl having in the range of 1 to 10 carbons, and a fluorinated alkoxy having in the range of 1 to 10 carbons, and, the remainder of R1, R2, R3, R4, R5, R6, if present, are individually selected from a hydrogen, a halogen other than fluorine, an alkyl having in the range of 1 to 10 carbons, a methoxyl group, a vinyl group, a propargyl group, an alkynyl having in the range of 1 to 10 carbons, a benzyl, a hydroxyl, an alkoxy having in the range of 1 to 10 carbons, an alkenoxy having in the range of 1 to 10 carbons, an alkynoxy having in the range of 1 to 10 carbons, an aryloxy group having in the range of 1 to 10 carbons, a heterocyclyloxy group having in the range of 1 to 10 carbons and up to 2 rings, a heterocyclyalkoxy group having in the range of 1 to 10 carbons, an oxo, a carboxyl, an ester and an ether. In further embodiments, the at least one of R1, R2, R3, R4 R5, R6 is CnHₓF_{y}, CH₂CₙHₓF_{y}, CH₂OCₙHₓF_{y}, and CF₂OCₙHₓF_{y}, where n is in the range of 1 to 5, x is in the range of 0 to 11, and y is in the range of 1 to 11.

In any of the above embodiments, the co-additive includes at least one of vinylene carbonate, 1,3,2-dioxathiolane 2,2-dioxide, lithium difluoro(oxalato)borate, and fluoroethylene carbonate.

According to various additional aspects, the present disclosure relates to a battery cell for a vehicle. The battery cell includes a cathode electrode including a cathode disposed on a cathode current collector, an anode electrode including an anode disposed on an anode current collector, a separator positioned between the cathode and the anode, and an electrolyte contacting the cathode, anode, and separator. The electrolyte includes an electrolyte according to any of the above embodiments. In embodiments, the electrolyte includes a carbonate solvent, a primary lithium salt including lithium hexafluorophosphate present in the solvent at a concentration in the range of 0.6 M to 2.0 M, a secondary lithium salt including lithium bis(fluorosulfonyl)imide present in the solvent in amount of 0.1 M to 0.5 M, wherein the total amount of the primary lithium salt and the secondary lithium salt is 2.0 M, a phenyl additive including at least one of a fluorine substituent and a fluorinated substituent present in an amount of 0.5 percent by weight to 20 percent by weight of the total weight of the electrolyte, and a co-additive present in the range 0.1 weight percent to 20 weight percent of the total weight of the electrolyte, wherein the remainder weight percent is the carbonate solvent, the primary lithium salt, and the secondary lithium salt, and the total weight of the electrolyte is 100 weight percent.

In embodiments of the above, the carbonate solvent includes a mixture of ethylene carbonate present in the range of 20 percent to 40 percent by volume of the solvent, and a linear carbonate present in the range of 60 percent to 80 percent by volume of the solvent, wherein the total percent by volume of the solvent is 100 percent.

In any of the above embodiments, the linear carbonate includes at least one of ethylene carbonate, ethyl methyl carbonate, and diethyl carbonate.

In any of the above embodiments, the carbonate solvent includes ethyl acetate is present in the range of 1 percent by weight to 20 percent by volume of the solvent, wherein the total percent by volume of the solvent is 100 percent.

In any of the above embodiments, the phenyl additive is fluorobenzene. Alternatively, or additionally, the phenyl additive exhibits the following formula:

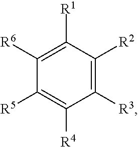

wherein at least one of R1, R2, R3, R4 R5, and R6 is a fluorine, a fluorinated alkyl having in the range of 1 to 10 carbons, and a fluorinated alkoxy having in the range of 1 to 10 carbons, and, the remainder of R1, R2, R3, R4, R5, R6, if present, are individually selected from a hydrogen, a halogen other than fluorine, an alkyl having in the range of 1 to 10 carbons, a methoxyl group, a vinyl group, a propargyl group, an alkynyl having in the range of 1 to 10 carbons, a benzyl, a hydroxyl, an alkoxy having in the range of 1 to 10 carbons, an alkenoxy having in the range of 1 to 10 carbons, an alkynoxy having in the range of 1 to 10 carbons, an aryloxy group having in the range of 1 to 10 carbons, a heterocyclyloxy group having in the range of 1 to 10 carbons and up to 2 rings, a heterocyclyalkoxy group having in the range of 1 to 10 carbons, an oxo, a carboxyl, an ester and an ether. In further embodiments, at least one of R1, R2, R3, R4 R5, R6 is CₙHₓF_{y}, CH₂CₙHₓF_{y}, CH₂OCₙHₓF_{y}, and CF₂OCₙHₓF_{y}, where n is in the range of 1 to 5, x is in the range of 0 to 11, and y is in the range of 1 to 11.

In any of the above embodiments, the anode is graphite and the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and optionally fluoroethylene carbonate is present in the range of 0.1 weight percent to 5 weight percent of the total weight percent of the electrolyte.

In alternative embodiments of the above, the anode is a silicon compound and graphite, wherein the silicon compound is present in the range of 5 percent by weight to 20 percent by weight of the anode and the graphite is present in the range of 80 to 95 percent by weight of the anode, and the total percent of the anode by weight is 100 percent, wherein the silicon compound includes at least one of silicon, lithiated silicon, silicon oxide (SiOₓ, wherein x is in the range of 1 to 2), lithiated silicon oxide, silicon carbon (SiC) and a silicon alloy, and wherein the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and optionally fluoroethylene carbonate is present in the range of 0.1 weight percent to 10 weight percent of the total weight percent of the electrolyte.

In further alternative embodiments of the above, the anode is a silicon compound and graphite, wherein the silicon compound is present in the range of 21 percent by weight to 50 percent by weight of the anode and the graphite is present in the range of 50 percent by weight to 79 percent by weight of the anode, and the total percent of the anode by weight is 100 percent, wherein the silicon compound includes at least one of silicon, lithiated silicon, silicon oxide (SiOₓ, wherein x is in the range of 1 to 2), lithiated silicon oxide silicon carbon (SiC) and a silicon alloy, and wherein the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and fluoroethylene carbonate is present in the range of 11 weight percent to 20 weight percent of the total weight percent of the electrolyte if present.

According to various further aspects, the present disclosure relates to a method of forming an electrolyte. The method includes mixing a carbonate solvent, a primary lithium salt including lithium hexafluorophosphate present in the solvent at a concentration in the range of 0.6 M to 2.0 M, a secondary lithium salt optionally present in the solvent in amount of 0.1 M to 0.5 M when present, wherein the total concentration of the primary lithium salt and the secondary lithium salt is 2.0 M, a phenyl additive including at least one of a fluorine substituent and a fluorinated substituent present in an amount of 0.5 percent by weight to 20 percent by weight of the total weight of the electrolyte, and a co-additive present in the range 0.1 weight percent to 20 weight percent of the total weight of the electrolyte, wherein the remainder weight percent is the carbonate solvent, the primary lithium salt, and the secondary lithium salt, and the total weight of the electrolyte is 100 weight percent.

### BRIEF DESCRIPTION OF DRAWINGS

The drawings described herein are for illustration purposes only and are not intended to limit the scope of the present disclosure in any way.

FIG. 1 illustrates a vehicle and a power train including a secondary battery according to embodiments of the present disclosure.

FIG. 2A illustrates a battery according to embodiments of the present disclosure.

FIG. 2B illustrates a pouch or prismatic battery cell according to embodiments of the present disclosure.

FIG. 2C illustrates a cylindrical battery cell according to embodiments of the present disclosure.

FIG. 2D illustrates a coin battery cell according to embodiments of the present disclosure.

FIG. 3 illustrates a method of forming a battery cell including a phenyl additive including at least of a one fluorine substituent and a fluorinated substituent in the electrolyte according to embodiments of the present disclosure.

FIG. 4 illustrates the state of charge (percentage) on the vertical, y-axis relative to time (minutes) on the horizontal, x-axis, measured at 25 degrees Celsius according to embodiments of the present disclosure.

FIG. 5 illustrates the capacity retention (percentage) on the vertical, y′-axis and the coulombic efficiency (percentage) on the vertical, y-axis, both, as a function of cycle number according to embodiments of the present disclosure.

FIG. 6 illustrates the state of charge (percentage) on the vertical, y-axis relative to time (minutes) on the horizontal, x-axis, measured at 25 degrees Celsius according to embodiments of the present disclosure.

FIG. 7 illustrates a graph of the capacity retention (percentage) on the vertical, y′-axis and the coulombic efficiency (percentage) on the vertical, y-axis, as a function of cycle number according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to an electrolyte containing a phenyl additive including at least one of a fluorine substituent and a fluorinated substituent, a battery cell for a vehicle including the electrolyte, a method of forming the electrolyte, and a method of forming a solid electrolyte interphase film on the anode electrode. The battery cells include any battery cell platform such as prismatic, pouch, cylindrical, or coin style battery cells. The battery cells may achieve an ultra-fast, 6C, charging rate, wherein 6C is understood as an 8 minute charge rate to 80 percent capacity from 0 percent capacity. The batteries may be used in electric or hybrid-electric vehicles.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as consumer electronics, power banks for buildings, and portable power stations used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

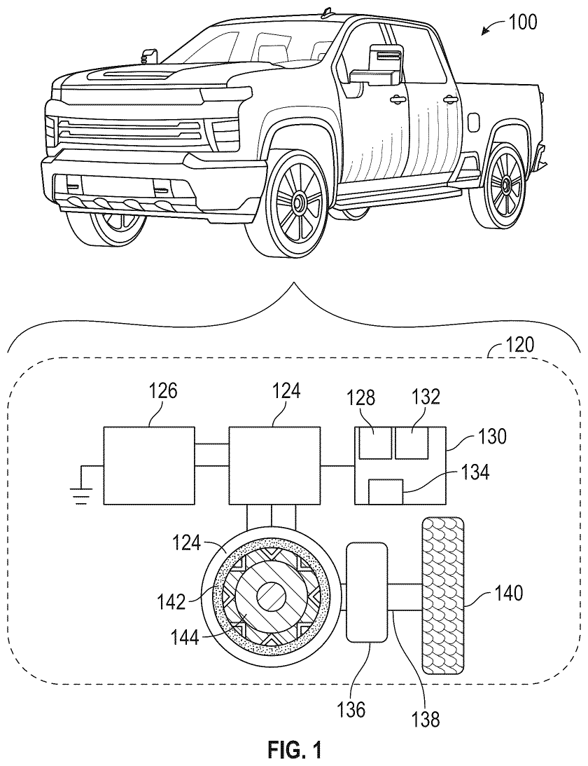

FIG. 1 illustrates a vehicle 100 including a propulsion system 120. The propulsion system 120 generally includes an electric motor 124 and a secondary battery 126 for powering the electric motor 124. Further, in many embodiments, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134. A combustible fuel powered engine may also be included in the propulsion system of hybrid-electric vehicles.

With reference again to the electric motor 124, the electric motor 124, powered by the battery 126, includes a stator 142 and a rotor 144 arranged within the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotating field (as caused by physical rotation) of the rotor 144 generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

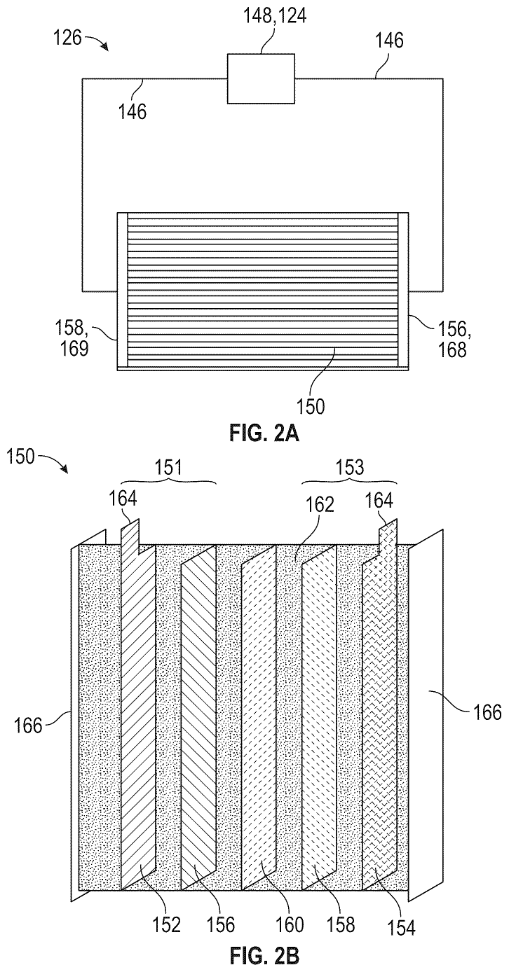

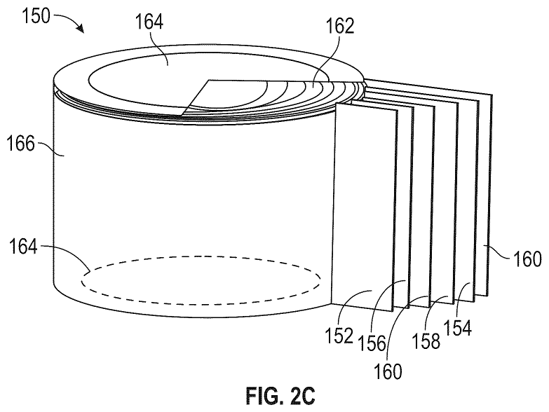

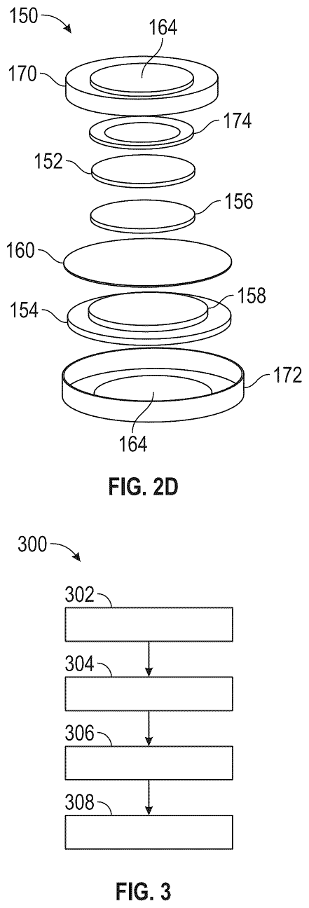

Reference is made to FIGS. 2A, 2B, 2C, and 2D illustrating an example of a secondary battery 126 for powering an electric vehicle 100, such as the electric vehicle 100 illustrated in FIG. 1. As noted above, secondary batteries 126 are understood as rechargeable batteries, that may be discharged upon application of a load and recharged upon the application of an external power source. Referring to FIGS. 2A, 2B, 2C, and 2D, a battery 126 is illustrated as being connected to a load 148, such as the electric motor 124. However, other loads 148 include various systems in the vehicle 100 such as climate control systems and infotainment systems. The battery 126 includes one or more battery cells 150, that are assembled together. The battery cells 150 may be, for example, pouch style, prismatic, cylindrical, or coin style battery cells, which are discussed further below. With reference to FIGS. 2B through 2D, when a load 148 is applied to the battery 126, Li+ ions move from the anode 158 to the cathode 156 through the separator 160 by way of the electrolyte 162. Equivalent electrons e-move through the circuitry 146 from the cathode 156 to the anode 158, providing voltage to the load 148. While charging, upon application of an external voltage, Li+ ions move from the cathode 156 to the anode 158 by way of the electrolyte 162 through the separator 160 and may be intercalated into the anode 158.

Each battery cell 150, such as those illustrated in FIGS. 2B, 2C, and 2D, generally includes a cathode current collector 152, a cathode 156 disposed on the cathode current collector 152, an anode current collector 154, an anode 158 disposed on the anode current collector 154, a separator 160 positioned between the cathode 156 and anode 158, and an electrolyte 162. While the illustrated battery cells 150 include one anode 158 (and anode current collector 154) and one cathode 156 (and one cathode current collector 152), the battery cell 150 may alternatively include two or more cathodes 156 (and one or more cathode current collectors 152) and one or more anodes 158 (and one or more anode current collectors 154). In further alternative embodiments, the battery cell 150 may include or one or more cathodes 156 (and one or more cathode current collectors 152) and two or more anodes 158 (and two or more anode current collectors 154). In any of the designs above, one or more separators 160 are interleaved between the cathodes 156 and anodes 158 to prevent the cathodes 156 and the anodes 158 from contacting.

In embodiments, the battery cell 150 of FIG. 2B is configured as a pouch style battery cell or in a prismatic battery cell. In either design, where multiple cathodes 156 and multiple anodes 158 are present, separators 160 are provided between the cathodes 156 and anodes 158. In embodiments, a ribbon shaped separator 160 may be z-folded around each cathode 156 (and cathode current collector 152) and around each anode 158 (and anode current collector 154). In a pouch style cell, tabs 164 are welded to the cathode current collectors 152 and the anode current collectors 154. Alternatively, the tabs 164 are formed integrally with the cathode current collectors 152 and anode current collectors 154 by cutting the tabs 164 with the cathode current collectors 152 and anode current collectors 154 from larger sheet stock. In addition, the covering 166 is in the form of a flexible film pouch formed of aluminum or another material. Prismatic style cells, on the other hand, include terminals that the cathode current collectors 152 and anode current collectors 154 are connected to and the covering 166 is formed of a relatively rigid casing, typically in the form of a cuboid. The tabs 164, or terminals, connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

Alternatively, the battery cell 150 of FIG. 2C is configured as a cylinder style battery cell 150. In this design, the cathode current collector 152, anode current collector 154, cathode 156, anode 158, and one or more separators 160 are in the form of long ribbons, which are rolled into a cylinder or jelly roll. Like the prismatic cell, the covering 166 is formed of a relatively rigid casing of aluminum or another material. Tabs 164 are welded to the cathode current collector 152 and anode current collector 154. The tabs 164 connected to the cathode current collectors 152 from multiple battery cells 150 are connected together, such as by a bus bar 168 (see FIG. 2A) or other electrical connection, and the tabs 164, or terminals, connected to the anode current collectors 154 from multiple battery cells 150 are connected together, such as by a bus bar 169 (see FIG. 2A) or other electrical connection.

In alternative embodiments, the battery cell 150 is packaged in a coin cell as illustrated in FIG. 2D. In this design, the cathode current collector 152, anode current collector 154, cathode 156, anode 158, and one or more separators 160 are in the form of discs, which are sandwiched together in the coin packaging forming the covering 166, which includes a cap 170 and a can 172. A spring washer 174 may be included between the cathode current collector 152 and the cap 170. Prior to securing the cap 170 on the can 172, electrolyte 162 is added to the battery cell 150. The cap includes terminals 164 for the anode 158 and cathode 156.

In the various styles of battery cells 150 noted above, the cathode current collector 152 and anode current collector 154 are formed from conductive materials. In embodiments, the cathode current collector 152 includes aluminum. Alternatively, or additionally, the cathode current collector 152 may include copper clad aluminum, and stainless steel. In embodiments, the anode current collector 154 includes copper. Alternatively or additionally, the anode current collector 154 may include nickel, stainless steel, and titanium. The current collectors 152, 154 are illustrated as being in the form of a foil; however, it should be appreciated that other forms may be exhibited such as mesh. In embodiments, a foil cathode current collector 152 and a foil anode current collector 154 are impermeable to gas. The cathode current collector 152 exhibits a thickness in the range of 5 micrometers to 50 micrometers, including all values and ranges therein, such as in the range of 5 micrometers to 25 micrometers. The anode current collector 154 exhibits a thickness in the range of 4 micrometers to 50 micrometers, including all values and ranges therein, such as in the range of 4 micrometers to 25 micrometers.

The cathode 156 includes a source of lithium ions (Li+) and can undergo reversible insertion or intercalation of lithium ions, determining e.g., the capacity and average voltage of a battery. In embodiments, the cathode material includes lithium iron phosphate, which exhibits an olivine type structure. Additional or alternatively, the cathode material includes lithium manganese iron phosphate also exhibiting an olivine type structure, lithium cobalt oxide, lithium nickel manganese oxides, lithium nickel manganese cobalt oxides, lithium nickel cobalt aluminum oxides, and lithium nickel cobalt manganese aluminum oxide. In embodiments, the lithium nickel manganese cobalt oxides having the formula LiNiₐMn_{b}Co_{c}O₂, wherein the sum of a, b, and c is 1 such as a LiNi_{0.33}Mn_{0.33}Co_{0.33}O₂ (NMC111), LiNi_{0.5}Mn_{0.3}Co_{0.2}O₂ (NMC 523), LiNi_{0.6}Mn_{0.2}Co_{0.2}O₂ (NMC 622), LiNi_{0.7}Mn_{0.2}Co_{0.1}O₂ (NMC 721), LiNi_{0.75}Mn_{0.25}O₂ (NM75), and LiNi_{0.8}Mn_{0.1}Co_{0.1}O₂ (NMC 811). In further embodiments, the lithium manganese oxide cathode, Li₂Mn₂O₄, is a spinel type cathode.

In embodiments, the cathode material is deposited on the cathode current collector 152 at a density in the range of 1.5 milliamp-hours per square centimeter to 5 milliamp-hours per square centimeter, including all values and ranges therein, such as from 1.7 milliamp-hours per square centimeter to 3.5 milliamp-hours per square centimeter. The cathode material includes particles that exhibit a particle size (largest linear cross-section as measured by optical microscopy) of in the range of 5 nanometers to 50 micrometers including all values and ranges therein. Further, in embodiments, the olivine cathode particles are coated with carbon particles. The carbon particles are present in the range of 0.9 percent by weight to 2 percent by weight of the total weight of the cathode particles. The cathode electrode 151, including both the cathode current collector 152 and the cathode 156, exhibits a thickness in the range of 10 micrometers to 500 micrometers including all values and ranges therein when the cathode material is formed on one side of the cathode current collector 152. When the cathode material is formed on both sides of the cathode current collector 152, the cathode electrode exhibits a thickness in the range of 30 micrometers to 1050 micrometers including all values and ranges therein for a double sided cathode electrode, such as in the range of 205 micrometers to 500 micrometers.

The anode 158 includes materials that can undergo reversible insertion or intercalation of lithium ions at a lower electrochemical potential than the cathode 156 material, such that an electrochemical potential difference exists between the anode 158 and cathode 156. In embodiments, the anode material includes graphite optionally in combination with a silicon compound. In embodiments, the graphite includes at least one of pure graphite and a surface modified artificial graphite. In further embodiments, the graphite is modified with at least one of hard carbon (also referred to as non-graphitizing carbon or char) and soft carbon (also referred to as graphitizing carbon). In embodiments, the graphite exhibits an average particle size of D50 between 6 micrometers and 20 micrometers. In addition, the graphite exhibits a surface area of 1 square meter per gram to 120 square meters per gram as measured by Brunauer-Emmett-Teller (BET) surface area analysis. The graphite further exhibits a Gra weight percent in the range of 50 weight percent to 100 weight percent. Further the tap density of the graphite is in the range of 0.5 grams per cubic centimeters to 1.5 grams per cubic centimeters including all values and ranges therein.

In further embodiments, the anode material includes graphite present in the range of 50 weight percent to 100 weight percent of the total weight of the anode, including all values and ranges therein, and a silicon compound present in the range of 0 weight percent to 50 weight percent of the total weight of the anode, including all values and ranges therein such as 0.1 weight percent to 50 weight percent, wherein the total weight of the anode is 100 percent. In further embodiments, the anode material includes graphite present in the range of 80 weight percent to 95 weight percent of the total weight of the anode, including all values and ranges therein, and the silicon compound present in the range of 5 weight percent to 20 weight percent of the total weight of the anode, including all values and ranges therein, wherein the total weight of the anode is 100 percent. In alternative embodiments, the anode material includes graphite present in the range of 50 weight percent to 79 weight percent of the total weight of the anode and the silicon compound present in the range of 21 weight percent to 50 weight percent of the total weight of the anode, including all values and ranges therein. The silicon compound includes at least one of silicon, silicon oxide (SiOx, wherein x is in the range of 1 to 2), lithiated silicon oxide (LSO), silicon carbon (SiC), and a silicon alloy such as silicon-titanium (SiTi), silicon niobium (Si—Nb), and silicon-aluminum (Si—Al). Lithiated silicon oxide exhibits the formula Li_{y}SiOₓ, wherein x is between 0 and 2 and y is between 0 and 1. The average particle size of the lithiated silicon oxide is 3 micrometers<D50<20 micrometers. The lithiated silicon oxide also exhibits a surface area of 0.5 square meter per gram to 10 square meters per gram as measured by Brunauer-Emmett-Teller (BET) surface area analysis. Further the tap density of the lithiated silicon oxide is in the range of 0.8 grams per cubic centimeters to 1.5 grams per cubic centimeters including all values and ranges therein. The silicon content is the silicon carbide is in the range of 30 weight percent to 60 weight percent of the silicon carbide, including all values and ranges therein. The average particle size of the silicon carbide is 3 micrometers<D50<20 micrometers. The silicon carbide also exhibits a surface area of 0.5 square meter per gram to 10 square meters per gram as measured by Brunauer-Emmett-Teller (BET) surface area analysis. Further the TD density of the silicon carbide is in the range of 0.6 grams per cubic centimeters to 1.5 grams per cubic centimeters including all values and ranges therein. Additionally, or alternatively, the anode material includes one or more tin oxide; aluminum; indium; zinc; germanium; and titanium oxide, as well as any combination of the above.

In embodiments, the anode material is deposited on the anode current collector 154 at a density in the range of 1.65 milliamp-hours per square centimeter to 5.5 milliamp-hours per square centimeter, including all values and ranges therein such as from 1.87 milliamp-hours per square centimeter to 3.85 milliamp-hours per square centimeter. Further, the press density, density after pressing, of the anode material is in the range of 1.3 grams per cubic centimeter to 2 grams per cubic centimeter, including all values and ranges therein, such as from 1.5 grams per cubic centimeter to 1.7 grams per cubic centimeter.

In embodiments, the anode 158 exhibits a thickness in the range of 10 micrometers to 550 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include one or more fillers dispersed therein, wherein the one or more fillers includes materials such as glass fiber, nonwoven fabrics, or woven fabrics. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of a film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions travel. The electrolyte 162 is a liquid electrolyte that permeates the separator 160 and generally includes a primary lithium salt, and optionally a secondary lithium salt, dissolved in a carbonate solvent with a phenyl additive including at least one of a fluorine substituent and a fluorinated substituent and a co-additive. The addition of the phenyl additive is understood to reduce the viscosity of the carbonate solvent and improves surface wettability of the electrolyte with the cathode 156. Further, the phenyl additive is understood to assist in the formation of a lithium fluoride solid electrolyte interphase at the anode 158. The addition of the phenyl additive is also understood to increase the charge rate for battery cells reaching up to 6C charging rates.

The primary lithium salt includes lithium hexafluorophosphate (LiPF₆). The lithium hexafluorophosphate is present in the solvent at a concentration (moles of salt per liter of solvent) of 0.6 molar (M) to 2.0 M, including all values and ranges therein, such as 0.9 M. The secondary lithium salt, if included in the electrolyte 162, includes lithium bis(fluorosulfonyl)imide (LiFSI). Additionally or alternatively, the secondary lithium salt includes one or more of the following: lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium hexafluoroarsenate (LiAsF₆), lithium trifluoromethanesulfonate (LiCF₃SO₃), lithium bis(trifluoromethane) sulfonylimide (LiN(CF₃SO₂)₂), and lithium bis(trifluoromethanesulfonyl) azanide (LiTFSA). The secondary lithium salt, if present, is present in the solvent at a concentration (moles of salt per liter of solvent) in the range of 0.1 M to 0.5 M, including all values and ranges therein, such as 0.3 M. The total concentration of the primary lithium salt and secondary lithium salt, if present, is up to 2.0 M, including all values and ranges from 0.6 M to 2.0 M, such as 1.2 M. In embodiments, for example, the primary lithium salt is present at 1.2 M. In another example, the primary lithium salt, lithium hexafluorophosphate (LiPF₆), is present at 0.9 M and the secondary lithium salt, lithium bis(fluorosulfonyl)imide (LiFSI), is present at 0.3 M. The combination of the lithium hexafluorophosphate (LiPF₆) and lithium bis(fluorosulfonyl)imide (LiFSI) were understood to enhance lithium ion conductivity.

In embodiments, the non-aqueous organic solvent includes a cyclic carbonate, a linear carbonate, and optionally an aliphatic carboxylic ester. The cyclic carbonate includes ethylene carbonate (EC). Additionally or alternatively the cyclic carbonate includes propylene carbonate (PC). The cyclic carbonate is present in the range of 20 percent by volume to 40 percent by volume of the total volume of solvent, including all values and ranges therein, such as 30 percent by volume.

The linear carbonate include at least one of ethylmethylcarbonate (EMC), dimethyl carbonate (DMC), and diethyl carbonate (DEC). The linear carbonate is present in the range of 60 percent by volume to 80 percent by volume of the total volume of solvent, including all values and ranges therein, such as 70 percent by volume. The use of the linear carbonates were found to reduce the viscosity of the solvent and improve battery cell charge rate capability.

The aliphatic carboxylic ester includes ethyl acetate (EA). Alternatively or additionally, the aliphatic carboxylic ester includes at least one of methyl acetate, propyl propionate, butyl acetate, isoamyl acetate, methyl butyrate, and ethyl butyrate. If present in the carbonate solvent, the aliphatic carboxylic ester is present in the range of 1 percent to 20 percent by volume. In embodiments, the aliphatic carboxylic ester is added to the electrolyte where battery formation occurs at temperatures below 50 degrees Celsius (° C.), such as in the range of 20 degrees Celsius to 49 degrees Celsius, including all values and increments therein, as the aliphatic carboxylic ester generally reduces the viscosity of the solvent. At temperatures above 50 degrees Celsius (° C.), such as in the range of 50 degrees Celsius to 80 degrees Celsius (° C.), including all values and ranges therein, the aliphatic carboxylic ester may be omitted. Battery formation is understood as the process, after assembling the battery cell, or battery, where the battery cell is electrically connected and the first charge is initiated and then repeatedly charged and discharged for a number of cycles. During battery formation solid electrolyte interphases such as lithium fluoride form, cathode electrolyte interphases form, structural changes occur to the cathode and anode materials, and, in embodiments, the cathode and anode current collectors corrode or dissolve. The use of ethyl acetate was also found to reduce the viscosity of the solvent and improve battery cell charge rate capability.

In embodiments, the phenyl additive includes fluorobenzene. Additionally or alternatively, the phenyl additive exhibits the following composition:

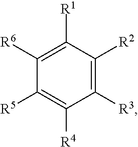

wherein at least one of R1, R2, R3, R4, R5, R6 is selected from a fluorine, a fluorinated alkyl having in the range of 1 to 10 carbons, and a fluorinated alkoxy having in the range of 1 to 10 carbons. In embodiments, one of, two of, three of, four of, five of, or all of R1, R2, R3, R4, R5, and R6 are individually selected from a fluorine, a fluorinated alkyl having in the range of 1 to 10 carbons, and a fluorinated alkoxy having in the range of 1 to 10 carbons. In further embodiments, the at least one of R1, R2, R3, R4 R5, R6 is CnHxFy, CH2CnHxFy, CH2OCnHxFy, and CF2OCnHxFy, where n is in the range of 1 to 5, x is in the range of 0 to 11, and y is in the range of 1 to 11. The phenyl additive including at least one fluorinated substituent additive was found to improve interface wettability between the electrolyte and the cathode and anode, assist in providing a lithium rich solid electrolyte interphase on graphite anodes including silicon carbide, and enhance lithium ion transport ability and prolong cyclability.

The remainder of R1, R2, R3, R4, R5, R6, if present, are individually one of a hydrogen, a halogen other than fluorine, an alkyl having in the range of 1 to 10 carbons, a methoxyl group, a vinyl group, a propargyl group, an alkynyl having in the range of 1 to 10 carbons, a benzyl, a hydroxyl, an alkoxy having in the range of 1 to 10 carbons, an alkenoxy having in the range of 1 to 10 carbons, an alkynoxy having in the range of 1 to 10 carbons, an aryloxy group having in the range of 1 to 10 carbons, a heterocyclyloxy group having in the range of 1 to 10 carbons and up to 2 rings, a heterocyclyalkoxy group having in the range of 1 to 10 carbons, an oxo, a carboxyl, an ester and an ether. As may be appreciated, if all of R1, R2, R3, R3, R4, R5, and R6 are individually selected from a fluorine, a fluorinated alkyl having in the range of 1 to 10 carbons, and a fluorinated alkoxy having in the range of 1 to 10 carbons, then a remainder of R1, R2, R3, R3, R4, R5, and R6 will not be present.

Further, the electrolyte 162 includes one or more co-additives, including at least one of the following: vinyl-ethylene carbonate (VC), 1,3,2-dioxathiolane 2,2-dioxide (DTD), lithium difluoro(oxalato)borate (LiDFOB), fluoroethylene carbonate (FEC), and combinations thereof. In embodiments, the electrolyte includes vinyl-ethylene carbonate (VC), 1,3,2-dioxathiolane 2,2-dioxide (DTD), lithium difluoro(oxalato)borate (LiDFOB) and, optionally, fluoroethylene carbonate (FEC). In such embodiments, the vinyl-ethylene carbonate (VC) is present in the range of 1 percent by weight to 5 percent by weight of the total weight of the electrolyte, including all values and ranges therein, such as 5 percent by weight, the 1,3,2-dioxathiolane 2,2-dioxide (DTD) is present in the range of 0.1 weight percent to 5 weight percent by weight of the total weight of the electrolyte, including all values and ranges therein such as 0.5 weight percent, the lithium difluoro(oxalato)borate (LiDFOB) is present in the range of 0.1 weight percent to 5 weight percent of the total weight of the electrolyte including all values and ranges therein such as 0.5 weight percent, and the fluoroethylene carbonate (FEC), if present, is present in the range of 0.1 weight percent to 20 weight percent of the total weight of the electrolyte, including all values and ranges therein such as 0.1 weight percent to 5 weight percent, 5 weight percent, or 15 weight percent. It should be appreciated that the total weight of the electrolyte includes the solvents, lithium salts, phenyl additive, and co-additives and totals 100 weight percent.

Regarding the fluoroethylene carbonate (FEC), in embodiments where the anode includes graphite, without a silicon compound, the fluoroethylene carbonate (FEC) may be omitted or present in the range of 0.1 weight percent to 5 weight percent of the total weight of the electrolyte, including all values and ranges therein. In embodiments where the anode includes 20 percent of a silicon compound or less, such as in the range of 0.1 percent by weight to 20 percent by weight of the total weight of the anode 158, fluoroethylene carbonate (FEC) may be present in the range of 1 percent by weight to 10 percent by weight of the total weight of the electrolyte, including all values and ranges therein such as 5 percent by weight. In embodiments where the anode includes 21 percent of a silicon compound or more, such as in the range of 21 percent by weight to 50 percent by weight of the total weight of the anode 158, fluoroethylene carbonate (FEC) may be present in the range of 11 percent by weight to 20 percent by weight of the total weight of the electrolyte, including all values and ranges therein such as 15 percent by weight.

The co-additives vinyl-ethylene carbonate, 1,3,2-dioxathiolane 2,2-dioxide (DTD), and fluoroethylene carbonate (FEC) were found to assist in forming uniform, flexible, and self-adaptive solid electrolyte interphases on anodes including a silicon carbide as they offset volume changes during charge and discharge. The lithium difluoro(oxalato)borate (LiDFOB) was found to improve the uniformity and robustness of the cathode-electrolyte interphase.

In examples, the electrolyte 162 includes one or more of the following formulations. For battery cells formed with battery formation of up to 50 degrees Celsius in temperature and an anode including graphite and 10 percent by weight silicon compound, 0.9 M lithium hexafluorophosphate (LiPF₆), 0.3 M lithium bis(fluorosulfonyl)imide (LiFSI) mixed in ethylene carbonate (EC) present at 30 percent by volume of the total volume of the solvent, dimethyl carbonate (DMC) present at 50 percent by volume of the total volume of the solvent, and ethyl acetate (EA) present at 20 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), 5 percent by weight of the total weight of the electrolyte fluoroethylene carbonate (FEC), and 5 percent by weight of the total weight of the electrolyte fluorobenzene. For battery cells formed with battery formation of 50 degrees Celsius to 80 degrees Celsius in temperature and an anode including graphite and 10 percent by weight silicon compound, 0.9 M lithium hexafluorophosphate (LiPF₆), 0.3 M lithium bis(fluorosulfonyl)imide (LiFSI) mixed in ethylene carbonate (EC) present at 30 percent by volume of the total volume of the solvent, and ethylmethylcarbonate (EMC) present at 70 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), 5 percent by weight of the total weight of the electrolyte fluoroethylene carbonate (FEC), and 5 percent by weight of the total weight of the electrolyte fluorobenzene.

For battery cells formed with battery formation of up to 50 degrees Celsius in temperature and a graphite anode (either pure graphite or modified artificial graphite), 0.9 M lithium hexafluorophosphate (LiPF₆), 0.3 M lithium bis(fluorosulfonyl)imide (LiFSI) mixed in ethylene carbonate (EC) present at 30 percent by volume of the total volume of the solvent, dimethyl carbonate (DMC) present at 50 percent by volume of the total volume of the solvent, and ethyl acetate (EA) present at 20 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), and 5 percent by weight of the total weight of the electrolyte fluorobenzene, wherein fluoroethylene carbonate (FEC) is omitted. For battery cells formed with battery formation of 50 degrees Celsius to 80 degrees Celsius in temperature and a graphite anode (either pure graphite or modified artificial graphite), 0.9 M lithium hexafluorophosphate (LiPF₆), 0.3 M lithium bis(fluorosulfonyl)imide (LiFSI) mixed in ethylene carbonate (EC) present at 30 percent by volume of the total volume of the solvent, and ethylmethylcarbonate (EMC) present at 70 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), and 5 percent by weight of the total weight of the electrolyte fluorobenzene, wherein fluoroethylene carbonate (FEC) is omitted.

The electrolyte 162 is formed by mixing the carbonate solvent, the primary lithium salt, optionally the secondary lithium salt, the phenyl additive including at least one fluorinated substituent, and the co-additive. The electrolyte 162 may then be added to a battery cell, including any one of the battery cells 150 illustrated in FIGS. 2B through 2D. FIG. 3 illustrates an embodiment of a method 300 of forming a battery cell 150 including the electrolyte 162. At block 302, the cathode current collector 152 with the cathode 156, the anode current collector 154 with the anode 158, and the separator 160 are assembled in a battery cell 150 covering 166, 170, 172. In embodiments, the cathode 156 is deposited onto the cathode current collector 152 prior to battery cell assembly 150 and the anode 158 is deposited onto the anode current collector 154 prior to battery cell assembly 150. At block 304, the electrolyte 162 is added to the battery cell 150. At block 306 the battery cell 150 is sealed. In further embodiments, at block 308 the battery cell 150 is coupled to a circuit and reformed. Battery formation occurs at temperatures below 50 degrees Celsius, such as in the range of 20 degrees Celsius to 50 degrees Celsius, or alternatively at elevated temperatures from 51 degrees Celsius to 80 degrees Celsius. As noted above, during battery formation solid electrolyte interphases such as lithium fluoride form on the anode, cathode electrolyte interphases form, structural changes occur to the cathode and anode materials, and, in embodiments, the cathode and anode current collectors corrode or dissolve.

### Examples

Two, 2 amp-hour pouch battery cells were constructed as described above. The first included a lithium iron phosphate cathode and a graphite anode of 100 percent pure graphite loaded at a density of 3.3 milliamp-hours per square centimeter. The second included a lithium iron phosphate cathode and a 90 percent graphite and 10 percent silicon carbide anode also loaded at a density of 3.3 milliamp-hours per square centimeter.

In the graphite anode pouch the electrolyte included 0.9 M lithium hexafluorophosphate (LiPF₆), 0.3 M lithium bis(fluorosulfonyl)imide (LiFSI) mixed in a carbonate solvent of ethylene carbonate (EC) present at 30 percent by volume of the total volume of the solvent, dimethyl carbonate (DMC) present at 50 percent by volume of the total volume of the solvent, and ethyl acetate (EA) present at 20 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), and 5 percent by weight of the total weight of the electrolyte fluorobenzene. The conductivity of the pouch measured at 25 degrees Celsius was 12.72 milliSiemens per centimeter.

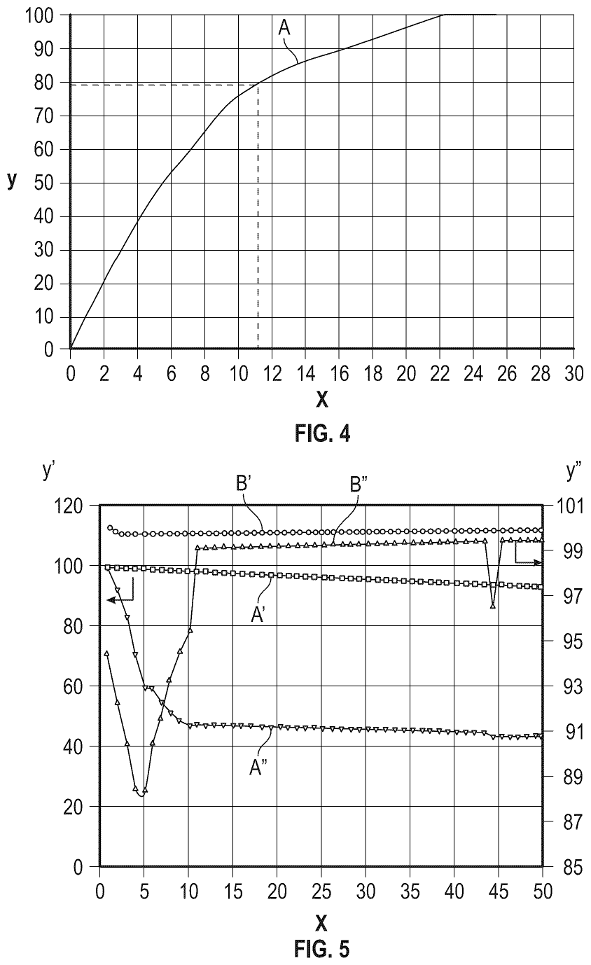

FIG. 4 illustrates the state of charge (percentage) on the vertical, y-axis relative to time (minutes) on the horizontal, x-axis, measured at 25 degrees Celsius. The voltage range was between 2.2 volts and 3.65 volts and the compression force applied was 69 kilopascals (10 pounds per square inch). The battery cell exhibited a state of charge A from 0 percent to 80 percent in 11.45 minutes demonstrating a 4.2C charge capability. FIG. 5 illustrates the capacity retention (percentage) on the vertical, y′-axis and the coulombic efficiency (percentage) on the vertical, y″-axis, both, as a function of cycle number. As illustrated, the electrolyte including the fluorobenzene exhibited relatively high capacity retention A′ of greater than 90 percent at 50 cycles and relatively little change in coulombic efficiency B′ over 50 cycles as compared to the capacity retention A″ and coulombic efficiency B″ of a baseline electrolyte without the fluorobenzene. The baseline electrolyte, as referenced herein includes 1.2 M of lithium hexafluorophosphate (LiPF₆), mixed in ethylene carbonate (EC) present at 30 volume percent of the entire volume of the solvent, ethylmethylcarbonate (EMC) present at 70 percent by volume of the total volume of the solvent, and 2 percent by weight of the total weight of the electrolyte vinyl-ethylene carbonate (VC).

In the pouch with the silicon carbide-graphite anode the electrolyte included 0.9 M lithium hexafluorophosphate (LiPF₆), 0.3 M lithium bis(fluorosulfonyl)imide (LiFSI) mixed in ethylene carbonate (EC) present at 30 percent by volume of the total volume of the solvent, dimethyl carbonate (DMC) present at 50 percent by volume of the total volume of the solvent, and ethyl acetate (EA) present at 20 percent by volume of the total volume of the solvent, combined with 2.5 percent by weight of the total weight of the electrolyte vinyl-ethylene carbonate (VC), 0.5 precent by weight of the total weight of the electrolyte 1,3,2-dioxathiolane 2,2-dioxide (DTD), 0.5 percent by weight of the total weight of the electrolyte lithium difluoro(oxalato)borate (LiDFOB), 5 percent by weight of the total weight of the electrolyte fluoroethylene carbonate (FEC), and 5 percent by weight of the total weight of the electrolyte fluorobenzene. The conductivity measured at 25 degrees Celsius was 12.32 milliSiemens per centimeter. Typical conductivities are less than 8 milliSiemens per centimeter for the baseline electrolyte without the fluorobenzene.

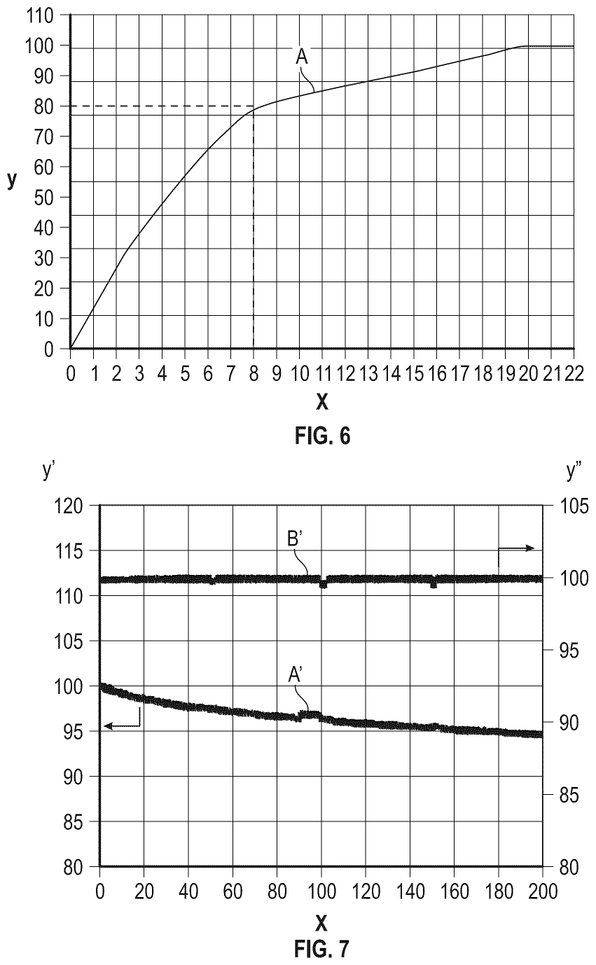

FIG. 6 illustrates the state of charge (percentage) on the vertical, y-axis relative to time (minutes) on the horizontal, x-axis, measured at 25 degrees Celsius. The voltage range was between 2.2 volts and 3.65 volts and the compression force was 69 kilopascals (10 pounds per square inch). The battery cell exhibited a state of charge A from 0 percent to 80 percent in 8 minutes demonstrating a 6C charge capability. FIG. 7 illustrates the capacity retention (percentage) on the vertical, y′-axis and the coulombic efficiency (percentage) on the vertical, y″-axis as a function of cycle number. As illustrated, the electrolyte including the fluorobenzene exhibited relatively high capacity retention A′ of 94.6 percent after 200 cycles and charge efficiency B′.

The electrolytes, battery cells, secondary batteries, and methods of making described herein offer a number of advantages. These advantages include, for example, a reduction in viscosity of the electrolyte by approximately 5 percent as compared to the baseline electrolyte without the fluorobenzene additive. These advantages additionally include improvement in the interface wettability of the electrolyte and lithium iron phosphate cathodes. These advantages also include forming a solid electrolyte interphase with the anode electrode. These advantages yet further include the formation of an ultra-fast, 6C, chargeable battery cell. In addition, these advantages include improved capacity retention and charge efficiency as compared to the baseline electrolyte without the additive.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semi composite conductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An electrolyte for a battery cell, the electrolyte comprising:
a carbonate solvent;
a primary lithium salt including lithium hexafluorophosphate present in the solvent at a concentration in the range of 0.6 M to 2.0 M;
a secondary lithium salt optionally present in the solvent at a concentration in the range of 0.1 M to 0.5 M, wherein the total concentration of the primary lithium salt and the secondary lithium salt if present is up to 2.0 M;
a phenyl additive including at least one of a fluorine substituent and a fluorinated substituent, the phenyl additive present in an amount of 0.5 percent by weight to 20 percent by weight of the total weight of the electrolyte; and
a co-additive present in the range 0.1 weight percent to 20 weight percent of the total weight of the electrolyte, wherein the remainder weight percent includes the carbonate solvent, the primary lithium salt, and the secondary lithium salt, and the total weight of the electrolyte is 100 weight percent.

2. The electrolyte of claim 1, wherein the secondary lithium salt is lithium bis(fluorosulfonyl)imide.

3. The electrolyte of claim 1, wherein the carbonate solvent includes a mixture of ethylene carbonate present in the range of 20 percent to 40 percent by volume of the solvent, and a linear carbonate present in the range of 60 percent to 80 percent by volume of the solvent, wherein the total percent by volume of the solvent is 100 percent.

4. The electrolyte of claim 3, wherein ethyl acetate is present in the range of 1 percent to 20 percent by volume of the solvent, wherein the total percent by volume of the solvent is 100 percent.

5. The electrolyte of claim 3, wherein the linear carbonate includes at least one of ethylene carbonate, ethyl methyl carbonate, and diethyl carbonate.

6. The electrolyte of claim 1, wherein phenyl additive is fluorobenzene.

7. The electrolyte of claim 1, wherein the phenyl additive exhibits the following formula: 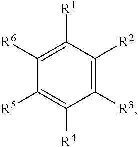
wherein at least one of R1, R2, R3, R4 R5, and R6 is a fluorine, a fluorinated alkyl having in the range of 1 to 10 carbons, and a fluorinated alkoxy having in the range of 1 to 10 carbons, and, the remainder of R1, R2, R3, R4, R5, R6, if present, are individually selected from a hydrogen, a halogen other than fluorine, an alkyl having in the range of 1 to 10 carbons, a methoxyl group, a vinyl group, a propargyl group, an alkynyl having in the range of 1 to 10 carbons, a benzyl, a hydroxyl, an alkoxy having in the range of 1 to 10 carbons, an alkenoxy having in the range of 1 to 10 carbons, an alkynoxy having in the range of 1 to 10 carbons, an aryloxy group having in the range of 1 to 10 carbons, a heterocyclyloxy group having in the range of 1 to 10 carbons and up to 2 rings, a heterocyclyalkoxy group having in the range of 1 to 10 carbons, an oxo, a carboxyl, an ester and an ether.

8. The electrolyte of claim 6, wherein the at least one of R1, R2, R3, R4 R5, R6 is CnHxFy, CH2CnHxFy, CH2OCnHxFy, and CF2OCnHxFy, where n is in the range of 1 to 5, x is in the range of 0 to 11, and y is in the range of 1 to 11.

9. The electrolyte of claim 1, wherein the co-additive includes at least one of vinylene carbonate, 1,3,2-dioxathiolane 2,2-dioxide, lithium difluoro(oxalato)borate, and fluoroethylene carbonate.

10. A battery cell for a vehicle, comprising:
a cathode electrode including a cathode disposed on a cathode current collector;
an anode electrode including an anode disposed on an anode current collector;
a separator positioned between the cathode and the anode; and
an electrolyte contacting the cathode, anode, and separator, wherein the electrolyte includes:
a carbonate solvent,
a primary lithium salt including lithium hexafluorophosphate present in the solvent at a concentration in the range of 0.6 M to 2.0 M,
a secondary lithium salt including lithium bis(fluorosulfonyl)imide present in the solvent in amount of 0.1 M to 0.5 M, wherein the total amount of the primary lithium salt and the secondary lithium salt is 2.0 M,
a phenyl additive including at least one of a fluorine substituent and a fluorinated substituent present in an amount of 0.5 percent by weight to 20 percent by weight of the total weight of the electrolyte, and
a co-additive present in the range 0.1 weight percent to 20 weight percent of the total weight of the electrolyte, wherein the remainder weight percent is the carbonate solvent, the primary lithium salt, and the secondary lithium salt, and the total weight of the electrolyte is 100 weight percent.

11. The battery cell of claim 10, wherein the carbonate solvent includes a mixture of ethylene carbonate present in the range of 20 percent to 40 percent by volume of the solvent, and a linear carbonate present in the range of 60 percent to 80 percent by volume of the solvent, wherein the total percent by volume of the solvent is 100 percent.

12. The battery cell of claim 11, wherein the linear carbonate includes at least one of ethylene carbonate, ethyl methyl carbonate, and diethyl carbonate.

13. The battery cell of claim 11, wherein the carbonate solvent includes ethyl acetate present in the range of 1 percent by weight to 20 percent by volume of the solvent, wherein the total percent by volume of the solvent is 100 percent.

14. The battery cell of claim 10, wherein the phenyl additive is fluorobenzene.

15. The battery cell of claim 10, wherein the phenyl additive exhibits the following formula: 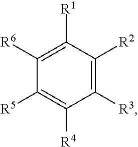
wherein at least one of R1, R2, R3, R4 R5, and R6 is a fluorine, a fluorinated alkyl having in the range of 1 to 10 carbons, and a fluorinated alkoxy having in the range of 1 to 10 carbons, and, the remainder of R1, R2, R3, R4, R5, R6, if present, are individually selected from a hydrogen, a halogen other than fluorine, an alkyl having in the range of 1 to 10 carbons, a methoxyl group, a vinyl group, a propargyl group, an alkynyl having in the range of 1 to 10 carbons, a benzyl, a hydroxyl, an alkoxy having in the range of 1 to 10 carbons, an alkenoxy having in the range of 1 to 10 carbons, an alkynoxy having in the range of 1 to 10 carbons, an aryloxy group having in the range of 1 to 10 carbons, a heterocyclyloxy group having in the range of 1 to 10 carbons and up to 2 rings, a heterocyclyalkoxy group having in the range of 1 to 10 carbons, an oxo, a carboxyl, an ester and an ether.

16. The battery cell of claim 16, wherein the at least one of R1, R2, R3, R4 R5, R6 is CnHxFy, CH2CnHxFy, CH2OCnHxFy, and CF2OCnHxFy, where n is in the range of 1 to 5, x is in the range of 0 to 11, and y is in the range of 1 to 11.

17. The battery cell of claim 10, wherein the anode is graphite and the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and optionally fluoroethylene carbonate is present in the range of 0.1 weight percent to 5 weight percent of the total weight percent of the electrolyte.

18. The battery cell of claim 10, wherein the anode is a silicon compound and graphite, wherein the silicon compound is present in the range of 5 percent by weight to 20 percent by weight of the anode and the graphite is present in the range of 80 to 95 percent by weight of the anode, and the total percent of the anode by weight is 100 percent, wherein the silicon compound includes at least one of silicon, lithiated silicon, silicon oxide (SiOx, wherein x is in the range of 1 to 2), silicon carbon (SiC) and a silicon alloy, and wherein the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and optionally fluoroethylene carbonate is present in the range of 0.1 weight percent to 10 weight percent of the total weight percent of the electrolyte.

19. The battery cell of claim 10, wherein the anode is a silicon compound and graphite, wherein the silicon compound is present in the range of 21 percent by weight to 50 percent by weight of the anode and the graphite is present in the range of 50 percent by weight to 79 percent by weight of the anode, and the total percent of the anode by weight is 100 percent, wherein the silicon compound includes at least one of silicon, lithiated silicon, silicon oxide (SiOx, wherein x is in the range of 1 to 2), silicon carbon (SiC) and a silicon alloy, and wherein the co-additive includes vinylene carbonate present in the range of 1 weight percent to 5 weight percent of the total weight percent of the electrolyte, 1,3,2-dioxathiolane 2,2-dioxide is present in the range of 0.1 weight percent to 5 weight percent of the total weight percent of the electrolyte, lithium difluoro(oxalato)borate is present in the range of 0.1 weight percent to 5 weight percent of the total weight percent of the electrolyte, and fluoroethylene carbonate is present in the range of 11 weight percent to 20 weight percent of the total weight percent of the electrolyte if present.

20. A method of forming an electrolyte, comprising:
mixing a carbonate solvent, a primary lithium salt including lithium hexafluorophosphate present in the solvent at a concentration in the range of 0.6 M to 2.0 M, a secondary lithium salt optionally present in the solvent in amount of 0.1 M to 0.5 M when present, wherein the total concentration of the primary lithium salt and the secondary lithium salt is 2.0 M, a phenyl additive including at least one of a fluorine substituent and a fluorinated substituent present in an amount of 0.5 percent by weight to 20 percent by weight of the total weight of the electrolyte, and a co-additive present in the range 0.1 weight percent to 20 weight percent of the total weight of the electrolyte, wherein the remainder weight percent is the carbonate solvent, the primary lithium salt, and the secondary lithium salt, and the total weight of the electrolyte is 100 weight percent.
